(19) United States
(12) Patent Application Publication
(10) Pub. No.: US 2021/0274275 A1
(43) Pub. Date: Sep. 2, 2021

(54) Ear Bud Case Protective Case and Locating Device

(71) Applicant: Caleb Daniels, Birmingham, AL (US)

(72) Inventor: Caleb Daniels, Birmingham, AL (US)

(21) Appl. No.: 16/805,285

(22) Filed: Feb. 28, 2020

(51) Int. Cl. H04R 1/10

(52) U.S. Cl. CPC H04R 1/1091; H04R 1/1025; H04R 2420/07; H04R 1/1016; H04R 1/1041

(57) ABSTRACT

The invention herein disclosed is a protective case made of a flexible material having frictional qualities that conforms to a pre-existing ear bud case. The protective case has a lid and a central body that receives an ear bud charging case. Connecting the lid and central body is a rear flexible hinge that is formed as part of the protective case such that the lid is connected to the central body as a unitary article. Located in the interior of the protective case is a cavity located on the interior front wall of the central body adapted to receive a locator device. Extending downward from the top edge and attached in the vicinity of the top edge of the interior front wall of the central body is a flap that covers the cavity and encapsulates the locator device. Upon installation of the locator device, the flap is pulled up and back and the locator device is installed and the flap the comes down to cover over the tracking device such that the tracking device is covered and does not come into direct contact with an ear bud case. Further disclosed is an ear bud case having an integrated locator device located therein and connected to the power source within an ear bud case having a pairing button that not only pairs to a mobile device for purposes of transmitting sound but also for purposes of locating the ear bud case.

### CROSS-REFERENCED TO RELATED APPLICATIONS

None

### FEDERALLY SPONSORED RESEARCH

None

### SEQUENCE LISTING

None

### FIELD OF THE INVENTION

The present invention relates to a protective case for an earbud case that protects the earbud case and also houses a removable tracking device within the protective case. Further disclosed is an ear bud case that further comprises a tracking device that a mobile device can communicate with.

### BACKGROUND OF THE INVENTION

With the advent of mobile cellular telephone devices there has also been the advent of ear speakers that allow for users to talk on their telephones without the need to hold their telephone. Early versions of ear phones, otherwise known as ear buds in the version where the ear speaker is insertable into an ear canal, was a wired connection that plugged into an appropriate jack on music playing device. However, more recent versions of ear buds wirelessly connect to a mobile device. These ear buds are typically small and easy to lose track of even though they are stored in a storage and charging case. Since the ear buds are small, the ear bud case is also small and is easily lost. In addition, present ear bud cases have a rechargeable power source and are integral to charging a rechargeable power source located within the ear buds. Without the case, the ear buds are unable to be charged and rendered useless until the case is found or a new case is purchased. Further, if the ear bud cases are dropped they can be damaged or broken. What is needed in the art is a protective case for an earbud case that allows for the installation of a third-party locator device such that the tracking device can pair with the mobile device. Additionally, what is needed in the art is an ear bud charging case further comprising a built-in tracking device that can wirelessly pair with a mobile device such as a cellular telephone, tablet or laptop.

### SUMMARY OF THE INVENTION

The invention herein disclosed is a protective case made of a flexible material having frictional qualities that conforms to a pre-existing ear bud case. The protective case has a lid and a central body that receives an ear bud charging case. Connecting the lid and central body is a rear flexible hinge that is formed as part of the protective case such that the lid is connected to the central body as a unitary article. Located in the interior of the protective case is a cavity located on the interior front wall of the central body adapted to receive a locator device. Extending downward from the top edge and attached in the vicinity of the top edge of the interior front wall of the central body is a flap that covers the cavity and encapsulates the locator device. Upon installation of the locator device, the flap is pulled up and back and the locator device is installed and the flap the comes down to cover over the tracking device such that the tracking device is covered and does not come into direct contact with an ear bud case. Further disclosed is an ear bud case having an integrated locator device located therein and connected to the power source within an ear bud case having a pairing button that not only pairs to a mobile device for purposes of transmitting sound but also for purposes of locating the ear bud case.

### BRIEF DESCRIPTION OF THE DRAWINGS

FIG. 1 is a perspective view of the protective case.

FIG. 2 is a perspective view of the protective case receiving an ear bud case.

FIG. 3 is a cross-sectional view of the protective case along the line A-A as depicted in FIG. 1.

FIG. 4. is a top perspective view looking into the central body of the protective case.

FIG. 5 is a rear perspective view of the protective case.

FIG. 6 is a cross sectional perspective view of the protective case along the line B-B.

### DETAILED DESCRIPTION

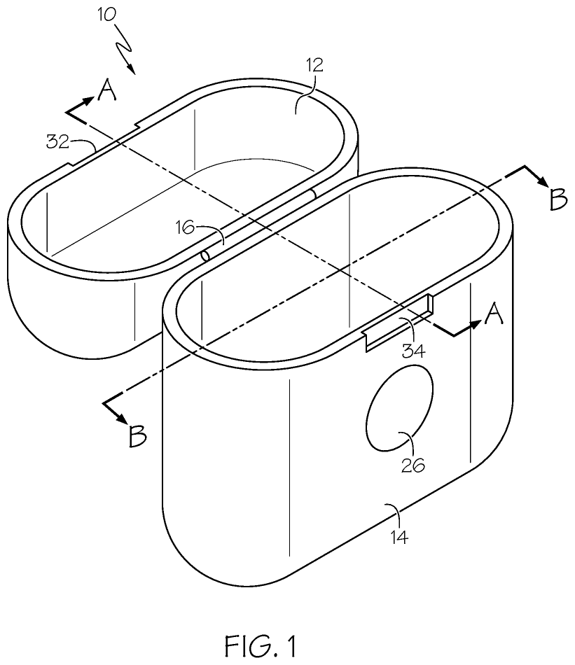

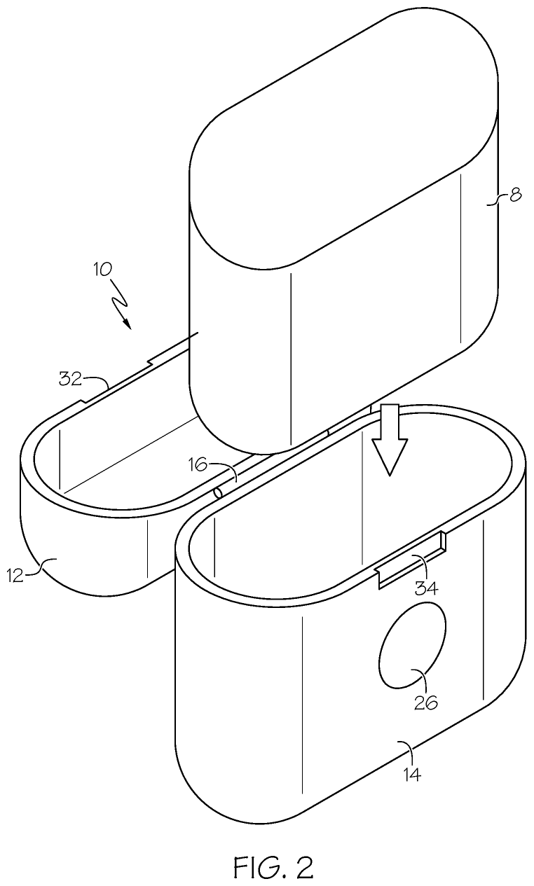

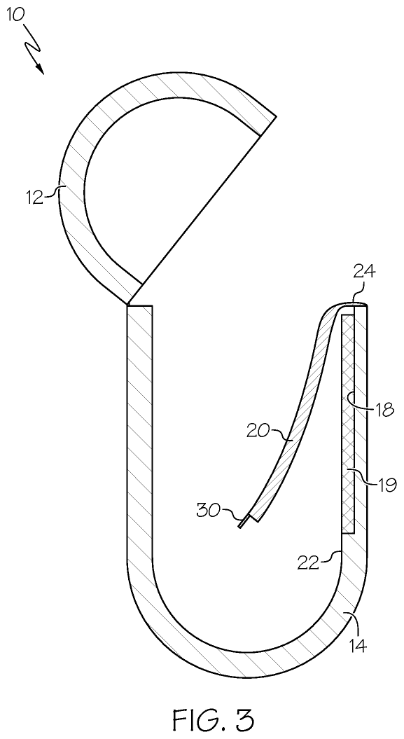

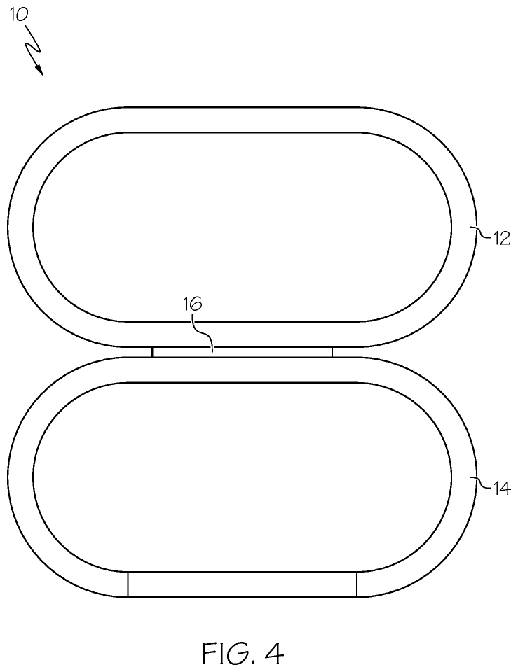

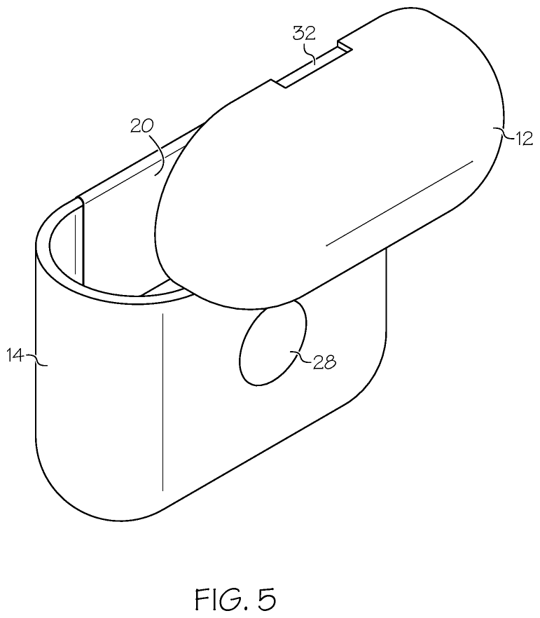

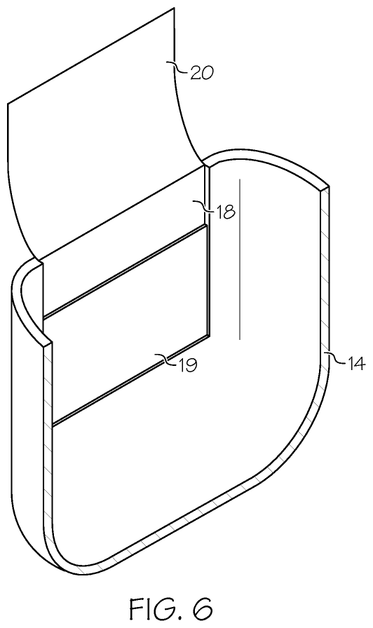

Regarding FIGS. 1-6, there is shown a protective case 10 for an ear bud case 8 having a lid 12 and a central body 14. The lid 12 and central body 14 are connected by a hinge 16. In one embodiment of the invention the lid 12, central body 14 and hinge 16 are an unitary article made from a flexible and frictional material such as silicone, rubber, latex or other similar material exhibiting similar characteristics. The primary method of manufacturing the protective case 10 is by way of injection molding. Located in the interior of the protective case 10 is a cavity 18 located on an interior sidewall of the central body 14 and adapted to receive a locator device 19. The cavity 18 is a formed depression in the interior sidewall that allows placement of the locator device 19 whereby the locator device is flush with the sidewall adjacent to the cavity and allows easy insertion of an ear bud case. The cavity can be formed in a variety of shapes such as square, rectangular, circular, elliptical or triangular among others The locator device 19 can be any variety of locating devices on the market such as a TILE® branded device or other similar devices that communicate by wireless connection with a user's mobile device utilizing a mobile application to actuate a siren or audible alarm on the locator device 19 to enable a user to recover a lost item. Adjacent to the cavity is a flap 20 that is flexible and extends over the cavity 18 such that the cavity 18 is covered. In one embodiment the flap 20 extends downward from the top edge 24 of the front interior sidewall 22 and covers the cavity 18 and encapsulates the locator device 19. Other embodiments could have the flap 20 starting from a distance down in the interior of the protective case 10 such that the flap 20 terminates towards the top of the protective case 10 or the flap 20 could start from a side on the interior of the protective case 10 and terminates on the other side of the sidewall of the protective case. The flap 20 allows for a locator device 19 to be segregated from an ear bud case 8 such that ear bud case 8 and locator device 19 are protected from each other and the flap 20 also serves as a compression device that allows the protective case 10 to be in firm frictional connection due to the flap 20 protruding a slight distance inward into the case. The flexible material such as silicone can compress and displace to a certain degree which allows tight frictional connection of the protective case 10 with the ear bud case 8. FIGS. 3 and 6 depict the flexible nature of the flap and show the cavity 18 that houses a locator device 19.

In a further embodiment the flap 20 on its interior side can have a semi-permanent adhesive coating that allows the flap to adhere to the locator device 19 such that when an ear bud case 8 is removed from the protective case 10 the flap 20 is not dislodged and pulled upward. The adhesive coating can have a peelable protective layer that can be removed prior to installation of a locator device 19. Located on the bottom edge of the flap is a tab 30 that allows a user to easily lift the flap 20 upwards and out of the protective case 10 when installing or removing a locator device.

The locator device 19 is installed into the cavity 18 with its actuator button oriented towards the front of the protective case 10 such that a user can activate the locator device 19 while it is mounted in the cavity 18. Located on the front of the central body 14 is a depressed divot 26 where the flexible material is thinner such that it allows a locator device 19 actuator button to easily be depressed. Located on the rear of the central body 14 is a depressed divot 28 where the flexible material is thinner such that it allows an ear bud case 8 power button to be actuated. Located on the lid 12 lower edge is a notch 32 that conforms to a notch 34 that allows a user's fingers to easily open the protective case 10 and the ear bud case 8. There is also disclosed an aperture 36 which allows an ear bud case 8 to be charged while installed in the protective case 10.

Further disclosed is an ear bud case 8 having an integrated locator device 19 or circuit located within. The ear bud case has a central body and receiving receptacles located in the interior of the central body that conform to individual earbuds for receipt and storage of said earbuds in said central body. Located within the earbud receptacle is a metal contact that mates with a metal contact located on an ear bud. Located within the ear bud case is a power source such as a rechargeable battery that is in communication with the metal contact that mates with the ear bud metal contact and allows a rechargeable power source within each individual ear bud to be charged by a rechargeable power source located within said ear bud case. Further disclosed is a microprocessor chip with an integrated wireless processor module such as BLUETOOTH® low energy module, an integrated charging circuit, and integrated locator module and logic that is communicable over a wireless network with a user interface on a mobile device adapted to communicate with said logic. Also disclosed is a speaker, siren, or other audible alarm located within the ear bud case and electrically connected to said microprocessor chip that provides audible alerts to a user when that user actuates the user interface of mobile application on a mobile device to locate the ear bud case.

### NUMERATED ELEMENTS

8 Ear bud case
10 Protective Case
12 Lid
14 Central Body
16 Flexible Hinge
18 Cavity
19 locator device
20 Flap
22 Front interior sidewall
24 Top edge of front interior sidewall
26 Depressed divot
28 Depressed divot
30 Tab
32 Notch
34 Notch
36 Aperture

What is claimed is:

1. A protective case for an ear bud case, comprising:
a lid and a central body that conform to the shape of an ear bud case such that said ear bud case can be inserted into said central body and said lid of the protective case conforms to a lid of the ear bud case whereby both lid and central body of the protective case are in frictional connection with a lid and a central body of said ear bud case;
a hinge that connects the lid to the central body whereby the hinge, lid and central body are a unitary article; and
a cavity formed in an interior sidewall of the protective case central body adapted to receive a locator device in the interior of the central body.

2. The protective case for an ear bud case of claim 1 wherein the lid, hinge, and central body are formed of a flexible and frictional material such as silicone, rubber and/or latex or other similar materials such that the hinge is flexible.

3. The protective case for an ear bud case of claim 2 further comprising a flap that extends from an interior sidewall of the central body that covers the cavity and locator device.

4. The protective case for an ear bud case of claim 3 wherein the flap is formed as an integral part of the protective case such that that the lid, central body, flexible hinge and the flap are a unitary article.

5. The protective case for an ear bud case of claim 4 wherein the flap can extend downward from a top interior edge of the central body, the flap can extend up from a location on an interior sidewall, or the flap can extend across from the side of an interior sidewall.

6. The protective case for an ear bud case of claim 4 wherein the interior surface of the flap has an adhesive coating that bonds to a locator device such that the flap stays in semi-permanent contact with the locator device such that removal of an ear bud case does not dislodge the flap from an adhered position on the locator device.

7. The protective case for an ear bud case of claim 6 further comprising a depressed divot on the exterior of the front sidewall of the protective case such that a button on the locator device can be actuated through the protective case.

8. The protective case for an ear bud case of claim 7 further comprising a depressed divot on the exterior of the rear sidewall of the protective case such that a pairing button on the ear bud case can be actuated through the protective case.

9. The protective case for an ear bud case of claim 8 further comprising an aperture on the bottom of the case that allows for installation of a charging cable into a charging port of an ear bud case.

10. The protective case for an ear bud case of claim 9 further comprising a notch on the outer edge of the lid and a corresponding notch on a top outer edge of the central body such that a user can obtain easy access to opening the protective case and ear bud case.

11. An ear bud case, comprising:
a lid portion;
a central body;
receiving receptacles that conform to individual earbuds for storage of said earbuds;
a power source located within said ear bud case;
a microprocessor chip with an integrated wireless processor module, integrated charging circuit, and integrated locator module and logic that is communicable over a wireless network with a user interface on a mobile device adapted to communicate with said logic;
charging contacts located in the bottom of an ear bud case that allow for electrical connection with individual ear buds; and
a speaker or siren located within the ear bud case and electrically connected to said microprocessor chip that provides audible alerts to a user when that user actuates the user interface of a mobile application on a mobile device to locate the ear bud case.
